(19) United States
(12) Patent Application Publication
(10) Pub. No.: US 2017/0237303 A1
(43) Pub. Date: Aug. 17, 2017

(54) Sheet Metal Part or Sintered Part for a Stator or a Rotor of an Electrical Machine and Method for Producing Same

(71) Applicant: Schuler Pressen GmbH, Göppingen (DE)

(72) Inventor: Jürgen Fahrenbach, Aichelberg (DE)

(21) Appl. No.: 15/502,403

(22) PCT Filed: Jun. 29, 2015
(86) PCT No.: PCT/EP2015/064752

§ 371 Date: Feb. 7, 2017

(30) Foreign Application Priority Data
Aug. 7, 2014 (DE) 10 2014 111 241.5

(51) Int. Cl. H02K 1/02; H02K 21/12; H02K 15/02; H02K 1/14; H02K 1/24

(52) U.S. Cl. CPC H02K 1/02; H02K 1/148; H02K 1/24; H02K 15/022; H02K 21/12

(57) ABSTRACT

A sheet-metal part or sintered part (10) for a stator or a rotor has a connection part (11) from which teeth (12) disposed at regular intervals project away. Each tooth has at least one first tooth segment (22) as well as at least one second tooth segment (23) produced from different magnetizable materials (M1, M2). In this way, the materials (M1, M2) can be used in targeted manner with regard to their magnetic and/or mechanical properties, in the region of the tooth (12), to optimize the magnetic and/or mechanical behavior of the tooth (12) and consequently of the sheet-metal part or sintered part (10). In particular, at least one first tooth segment (22) has a saturation magnetization BS1 greater than that of the remainder of the sheet-metal part or sintered part (10).

The invention relates to a sheet-metal part or sintered part for a stator or a rotor of an electrical machine, for example of an electric motor. Accordingly, this sheet-metal part or sintered part can also be referred to as a rotor sheet or stator sheet. The invention furthermore relates to a method for the production of such a sheet-metal part or sintered part. The rotor can move so as to rotate about an axis of rotation or, in the case of an electrical machine that works in translational manner, can move along the stator.

It is known to connect laminated cores composed of a plurality of sheet-metal parts or sintered parts with one another by means of punch-packeting, adhesion or the like. Such a laminated core is then a component of a rotor or of a stator of an electric motor.

Each sheet-metal part or sintered part has a connection part from which multiple teeth extend away. For an electrical machine driven rotationally, the connection part is structured as a ring part that is closed in a circumference direction, about an axis of rotation. The teeth extend away from the connection part, radially relative to the axis of rotation, either toward the outside or toward the inside. In the case of an electrical machine in which the rotor moves along the stator translationally on a movement path, the connection part preferably extends in a straight line or also a curved line, and the teeth preferably project away from the connection part at a right angle to the movement direction of the rotor and are particularly oriented parallel to one another.

A tooth head that is connected with the connection part by way of a tooth strip is present at the free end of every tooth. The tooth head has a tooth head surface from which the magnetic field lines exit from the sheet-metal part or sintered part.

Multiple attempts have already been made to improve the efficiency of electrical machines by optimization of the sheet-metal parts or sintered parts, i.e. of the laminated cores produced from the sheet-metal parts or sintered parts.

For example, DE 10 2012 213 239 A1 proposes using two different types of sheet-metal parts or sintered parts and stacking these sheet-metal parts alternately in the laminated core, one on top of the other. The different sheet-metal parts are produced from different materials. One sheet-metal part can consist of a nickel/iron alloy, and the other sheet-metal part can consist of an iron/cobalt alloy. In this way, sheet-metal parts having a low loss number, on the one hand, are supposed to be combined with great saturation flow density, on the other hand, to produce a laminated core.

In DE 10 2010 049 178 A1, an electrical machine is proposed, which is supposed to allow operation in a large range of speeds of rotation. In particular, the proportions of the stator current at high speeds of rotation are supposed to be reduced. For this purpose, the rotor is supposed to have a means for setting a magnetic field intensity or flow density of the stator proportion of the exciter field generated by the rotor. To achieve this, the magnetic resistance within the rotor can be changed by means of a recess or an insertion element inserted into the recess.

It is also known to optimize the efficiency of an electrical machine by means of the contour or geometry of the sheet-metal parts that form the laminated core of the stator or of the rotor. However, it has been shown that these optimization attempts encounter certain limits.

Proceeding from the state of the art, the present invention is based on the task of creating a sheet-metal part or sintered part with which an improved electrical machine can be produced.

This task is accomplished by means of the creation of a sheet-metal part or sintered part for a stator or a rotor of an electrical machine, having the characteristics of claim 1. A method according to the invention, for the production of such a sheet-metal part or sintered part, is indicated in claim 16.

The sheet-metal part or sintered part is used to create a core or laminated core of a stator or a rotor. An electrical machine can thereby have a core or laminated core composed of multiple sheet-metal parts or sintered parts according to the invention, in the rotor and/or in the stator. For an electrical machine that works rotationally, the sheet-metal part or sintered part has a connection part that is closed in ring shape in a circumference direction, about an axis of rotation. Multiple teeth project away from the connection part. The teeth are disposed so as to be distributed at equal intervals in the circumference direction, about the axis of rotation.

For an electrical machine that works translationally (e.g. linear drive), the sheet-metal part or sintered part has a connection part that extends in a straight or curved line along the movement path of a rotor, from which part the teeth extend away, preferably at equal intervals.

The teeth have a tooth strip that is connected with the connection part. A tooth head is present at the free end of each tooth, opposite to the connection part. In the installed position during operation of the electrical machine, magnetic field lines exit or enter at the tooth head, particularly at a tooth head surface having one expanse component that runs in the circumference direction, about the axis of rotation, and another expanse component that runs along the axis of rotation (machine that works rotationally). The tooth head surface faces away from the connection part in the case of a sheet-metal part or sintered part for a machine that works translationally, and has an expanse component in the movement direction of the rotor and another expanse component at a right angle to that.

According to the invention, each tooth consists of at least two different magnetizable materials. Each tooth has at least one first tooth segment composed of a first magnetizable material and at least one second tooth segment composed of a second magnetizable material. The two magnetizable materials differ from one another. As a result, it is possible to produce those parts of a tooth in which a magnetic field having great magnetic flow density occurs during operation of the electrical machine, at least part of the time, from a material that has correspondingly great saturation magnetization. Such materials having great saturation magnetization are generally expensive. Furthermore, in some cases they do not have sufficient magnetic permeability or sufficient mechanical stability. Other magnetizable materials, once again, although they are sufficiently mechanically stable and/or have great magnetic permeability, nevertheless have low saturation magnetization. By means of the configuration of the teeth according to the invention, with at least one first tooth segment and at least one second tooth segment composed of different materials, in each instance, the materials can be used in targeted manner with regard to their magnetic and/or mechanical and/or physical properties, in the spatial segment of the tooth, in order to obtain an improved sheet-metal part or sintered part, in total, with regard to the magnetic and/or physical and/or mechanical properties.

For example, an iron alloy having a proportion of at least 45% or at least 50% cobalt can be used as the first material. Also, iron alloys having nickel components and/or molybdenum components can be used.

Preferably, what are call “mu-metals” or iron alloys having nickel components and/or silicon components are used as the second material.

The connection part of the sheet-metal part or sintered part can be produced from the same material as the second tooth segment.

Both the first material and the second material are preferably a soft-magnetic material. In particular, the entire sheet-metal part or sintered part is produced from two or more soft-magnetic materials.

Preferably, the first material has greater saturation magnetization than the second material. The saturation magnetization of the first material can amount to at least 2.0 T or 2.3 T or 2.5 T or 3.0 T, for example. The saturation magnetization of the second material preferably amounts to maximally 1.0 T.

In a preferred exemplary embodiment, the relative permeability of the first material is less than that of the second material. For example, the first material has a relative permeability of at most 20,000. The relative permeability of the second material can be at least 30,000 and, in one exemplary embodiment, can lie in the range of 100,000 to 200,000.

Preferably, the volume proportion of the first material of a tooth is less than the volume proportion of the second material of the same tooth.

In one exemplary embodiment, the first tooth segment forms at least a part of the tooth head. In one exemplary embodiment, the entire tooth head can be formed by the first tooth segment. In another exemplary embodiment, the tooth head can have a tooth segment that has at least part of the tooth head surface from which the magnetic field lines exit or into which they enter during operation of the electrical machine.

Viewed in the circumference direction about the axis of rotation or viewed in the movement direction of the rotor, the tooth head can have two end sections that lie opposite one another. At least one of these two end sections can be formed by a first tooth segment and consequently can consist of a first material. In the region of these end sections, great magnetic flow density, in terms of amount, can form during rotation of the rotor relative to the stator. It is therefore advantageous to provide a first tooth segment in at least one of these end sections, which segment consists of a material having great saturation magnetization.

If the electrical machine is supposed to have an equally great drive moment or torque in both directions of movement or rotation, it is advantageous to form both end sections of the tooth head by means of a first tooth segment, in each instance. In the case of electrical machines that are operated only or mainly in one drive direction or rotation direction, it can be sufficient to form only one end section of the tooth head by means of a first tooth segment.

It is possible to structure the tooth to be asymmetrical relative to a longitudinal center plane or symmetrical to the longitudinal center plane, with regard to the materials used. The longitudinal center plane is formed by a radial plane that extends through the center of the tooth or tooth strip. If, for example, only a single first tooth segment is present, then the tooth can be structured asymmetrically relative to the longitudinal center plane, in that this first tooth segment is not disposed symmetrically relative to the longitudinal center plane. If two or more first tooth segments are present, the tooth can be structured symmetrically or also asymmetrically relative to the longitudinal center plane. An asymmetrical structure with two first tooth segments is achieved, for example, if the two first tooth segments disposed on opposite sides of the longitudinal center plane have a different shape and/or size.

Preferably, the second tooth segment forms at least a part of the tooth strip. In particular, at least one section between the connection part and the tooth head of the tooth strip is formed by the second tooth segment.

It is advantageous if the connection part and the second tooth segment and/or the tooth strip consist of the same material. In this way, it is possible to produce the tooth strips of the teeth and the connection part at the same time during production of the sheet-metal part or sintered part, for example by removing them from a starting metal sheet. It is furthermore possible that a center section of the tooth head, viewed in the circumference direction about the axis of rotation or in the movement direction of the rotor, consists of the same material as the tooth strip and/or the connection part.

In one exemplary embodiment, it is also possible that the connection part consists of a magnetizable third material that differs from the first and the second material. In this way, the sheet-metal part or sintered part can be further optimized with regard to its magnetic and/or mechanical and/or physical properties.

It is advantageous if the second material and/or the third material demonstrate(s) greater mechanical stability than the first material. In this regard, mechanical stability is understood to be the tensile strength and/or the modulus of elasticity and/or the hardness.

In a preferred exemplary embodiment, a groove that passes through the tooth head surface can be present in a tooth head. Such a groove serves to reduce the radial forces during operation of the electrical machine.

The at least one first tooth segment and the at least one second tooth segment are connected with the adjacent part of the sheet-metal part or sintered part, in each instance, with a form-fit connection and/or material-fit connection and/or force-fit connection. The material-fit connection can be produced, for example, by means of adhesion, welding, punch-packeting or laser welding. Additionally or alternatively, undercut contours can be formed in the regions to be connected, in order to produce form-fit engagement.

To produce the sheet-metal part or sintered part, the method of procedure can be as follows:

First, the at least one first tooth segment and the at least one second tooth segment are produced. For example, the tooth segments can be removed from a respective starting metal sheet by means of cutting, punching, laser cutting, water-jet cutting or the like. Subsequently, the tooth segments that have been produced are connected with one another with a material-fit connection and/or a form-fit connection and/or force-fit connection.

The second tooth segments of the teeth can be produced integrally, without a seam location and join location, together with the connection part, for example removed from a starting metal sheet at the same time with the connection part. If the connection part and the second tooth segments of the sheet-metal part or sintered part are produced from different materials, the second tooth segments are connected with the connection part before or after the connection with the respective at least one related first tooth segment takes place.

Additionally or alternatively, it is also possible to remove the first and/or second tooth segments from a starting metal sheet by means of punching according to a punching method, in which the starting metal sheet is clamped in place by way of a sheet-metal holding device. The clamping force of the sheet-metal holding device can be varied as a function of the position of a punch that carries the punching tool, in order to improve the quality of the punched edges. Such a method is described in EP 1 602 419 A1. With reference to punching the sheet-metal part or sintered part, i.e. the tooth segments or the connection parts out from a respective starting metal sheet, reference is explicitly made here to the method described in EP 1 602 419 A1.

Advantageous embodiments of the invention are evident from the dependent claims, as well as the specification and the drawing. In the following, preferred exemplary embodiments will be explained in detail, using the attached drawing. The figures show:

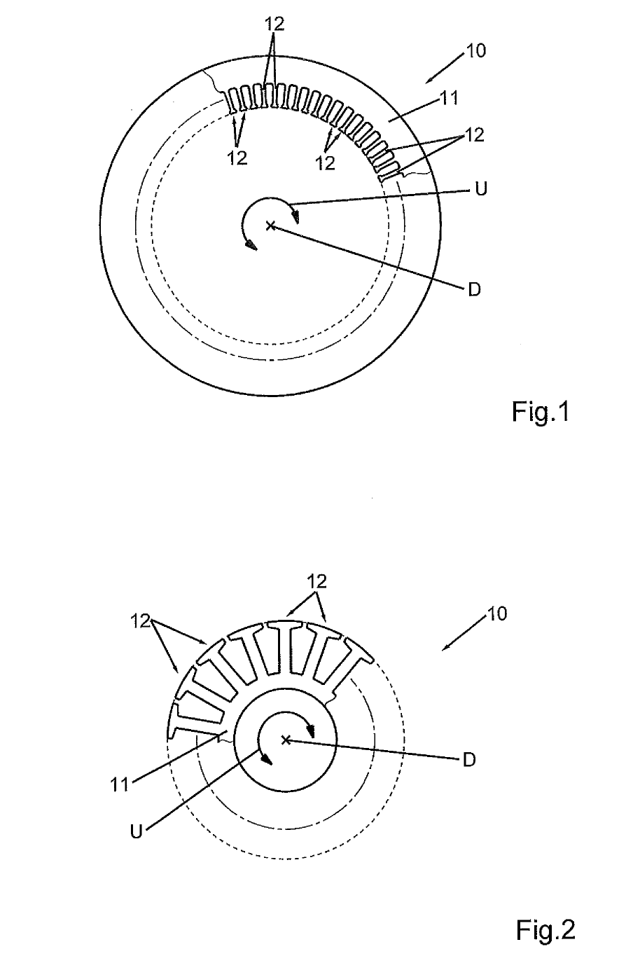

FIG. 1, a schematic partial representation of a sheet-metal part or sintered part for a rotor, in a side view,

FIG. 2, a schematic partial representation of a sheet-metal part or sintered part for a stator, in a side view,

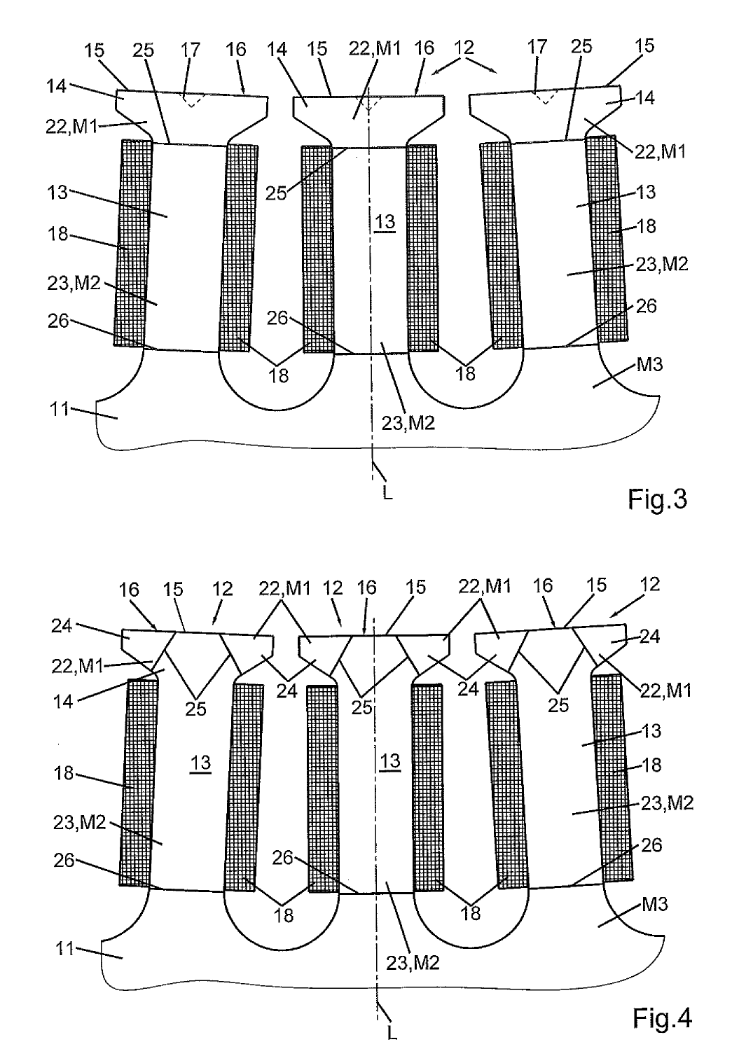

FIGS. 3 to 6, an exemplary embodiment, in each instance, of a tooth having multiple tooth segments, which tooth is a component of a sheet-metal part or sintered part according to FIG. 1 or 2, and

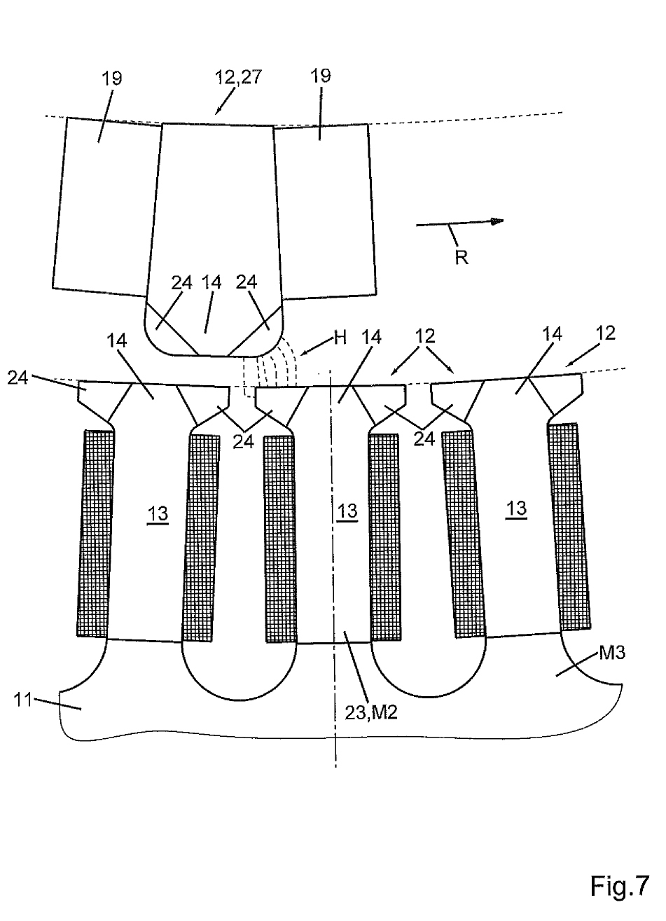

FIG. 7, a schematic diagram of a part of the magnetic field between a tooth of a rotor and a tooth of a stator.

In FIG. 1, in a schematic partial representation, a sheet-metal part 10 for a rotor of an electric motor is illustrated. A laminated core for the rotor is produced from multiple such sheet-metal parts 10. The sheet-metal parts 10 are connected to produce a laminated core by means of adhesion, punch-packeting or other means, for example.

In FIG. 2, a further exemplary embodiment of a sheet-metal part 10 is illustrated schematically; it is used in a stator of an electric motor. As in the case of the rotor, multiple such sheet-metal parts 10 are layered or stacked and connected to produce a laminated core in the case of the stator, as well.

In place of the sheet-metal parts 10 used as examples here in connection with the drawing, alternatively sintered parts composed of a sintered material can also be used.

The sheet-metal parts 10 according to FIGS. 1 and 2 have a form for producing an outer rotor motor. In this regard, the rotor encompasses the stator, which is disposed radially farther toward the inside. It is understood that other embodiments, with a stator disposed radially on the outside and a rotor disposed radially on the inside (inner rotor motor), can also be produced.

The sheet-metal part 10 has a connection part 11 that is closed in ring shape in a circumference direction U, about an axis of rotation D. Multiple teeth 12 project away from the connection part 11. The number of teeth 12 varies and depends on the design of the stator or rotor. The dimensioning of the teeth 12 and their contour can also vary. The teeth 12 extend radially relative to the axis of rotation D. The teeth 12 of the sheet-metal part 10 can extend radially outward, as illustrated in FIG. 1, proceeding from the connection part 11 radially inward or, as illustrated in FIG. 2, proceeding from the connection part 11 radially outward. In FIGS. 1 and 2, only part of the sheet-metal part 10 is illustrated, in each instance, viewed in the circumference direction U. The sheet-metal parts 10 are completely closed in the circumference direction U, with the teeth 12 being disposed so as to be distributed at equal intervals in the circumference direction U.

This ring-shaped embodiment of a sheet-metal part or sintered part 10 is provided for electrical machines that work rotationally. In a modification of the exemplary embodiments shown, the connection part 11 can also extend in a straight line or curved along a movement path of a rotor of an electrical machine that works translationally (linear drive or linear generator). In this regard, the teeth 12 project at a right angle to the movement path or movement direction of the rotor, away from the connection part 11. For the remainder, the sheet-metal part or sintered part 10 can be structured for the stator or rotor of an electrical machine that works translationally, corresponding to the sheet-metal parts or sintered parts 10 that are explained in connection with the drawing. In this regard, the circumference direction about the axis of rotation must be replaced with the linear movement direction of the rotor.

In FIGS. 3 to 7, a detail of a sheet-metal part 10 having multiple teeth 12 is shown on a larger scale, in each instance. Using these figures, the structure of the teeth 12 will be explained. All the teeth 12 of a sheet-metal part 10 have the identical structure, so that it is sufficient to explain the structure of a single tooth 12.

Each tooth 12 has a tooth strip 13 that is connected with the connection part 11. The tooth strip 13 extends radially relative to the axis of rotation D, proceeding from the connection part 11. At the end of the tooth strip 13 facing away from the connection part 11, the tooth 12 has a tooth head 14. In the circumference direction U, the tooth head 14 can project beyond the tooth strip 13 on both sides and widen the tooth 12 in its expanse direction, toward its free end 15. The tooth shape or tooth contour can be symmetrical or asymmetrical relative to a longitudinal center plane L of the tooth 12. In the exemplary embodiments illustrated here, the tooth shape, in other words the outer contour of the tooth 12, is structured to be symmetrical relative to the longitudinal center plane L. The longitudinal center plane L extends through the center of the tooth strip 13 and forms a radial plane relative to the axis of rotation D.

At its free end 15, the tooth 12 has a tooth head surface 16. The tooth head surface 16 has an expanse component in the circumference direction U, and an expanse component parallel to the axis of rotation D. Preferably, the tooth head surfaces 16 of the teeth 12 run along a common cylinder mantle surface about the axis of rotation D, as illustrated schematically in FIGS. 1 and 2.

In one exemplary embodiment, the tooth head surface 16 can be divided into two surface sections that are separated from one another by means of a groove 17 (FIG. 3). The groove 17 extends parallel to the axis of rotation D, in the region of the free end 15, through the tooth head 14. The groove 17 is optional and can be present in the teeth 12 in all the embodiments of the sheet-metal part 10 that have been described.

Each tooth has at least one first tooth segment 22 and at least one second tooth segment 23. The first tooth segment 22 consists of a magnetizable first material M1. The second tooth segment 23 consists of a magnetizable second material M2. In the exemplary embodiment, the first material M1 and the second material M2 are each a soft-magnetic material. The two materials M1, M2 differ from one another.

As is illustrated in FIGS. 3 to 7, a winding 18 of the stator or of the rotor of an electrical machine is present in the region between two adjacent teeth 12 or between two adjacent tooth strips 13. The winding 18 is illustrated in highly schematic manner, in each instance. In place of such a winding 18, permanent magnets 19 can also be disposed on a stator or a rotor, between adjacent teeth 12 (FIG. 7).

In the preferred exemplary embodiments described here, the at least one first tooth segment 22 forms at least a part of the tooth head 14 of a tooth 12. In the first exemplary embodiment according to FIG. 3, the tooth head 12 [sic—should be 14] as a whole is formed by a first tooth segment 22. Here, the tooth strip 13 is formed by the second tooth segment 23. The first tooth segment 22 and consequently the tooth head 14 are connected with the tooth strip 13 or the second tooth segment 23 at a first connection location 25. The second tooth segment 23 is connected with the connection part 12 at a second connection location 26.

According to the example, the first material M1 of the first tooth segment 22 has a first saturation magnetization B_{S1} and the second material has a second saturation magnetization B_{S2}. The first saturation magnetization B_{S1} is greater than the second saturation magnetization B_{S2}. The first saturation magnetization B_{S1} preferably amounts to at least 2.0 T or 2.3 T or 2.5 T. The second saturation magnetization B_{S2} preferably amounts to maximally 1.0 T.

The first material has a first relative permeability μᵣ₁ that is less than the second relative permeability μᵣ₂ of the second material M2. The second relative permeability μᵣ₂ is preferably greater than 30,000 or greater than 100,000 and can lie in the range from 100,000 to 200,000. The first relative permeability μᵣ₁ is preferably less than 20,000.

The first material M1 can be an iron alloy with a proportion of at least 45% or at least 50% cobalt. Alloys having a nickel component or molybdenum component or combinations of these can also be used. Preferably what is called a mu-metal is used as the second material. The second material can be an iron alloy with a nickel component or a silicon component.

The materials that can be used as the second material M2 can also be used for the connection part 11, but no material identity needs to exists between the connection part 11 and the second tooth segment 23, although the use of identical materials for the connection part 11 and the second tooth segment 23 is possible in a sheet-metal part 10 and can be advantageous for simplifying the production of the structure of the sheet-metal part 10.

Because of the fact that the at least one first tooth segment 22 forms at least a part of the tooth head 14, and the at least one second tooth segment 23 forms at least a part of the tooth strip 13, the optimal materials M1 and M2, in each instance, can be used for the two tooth segments 22, 23, with regard to the magnetic and/or mechanical and/or physical properties. The tooth 12 or the sheet-metal part 10 can thereby be optimized and the material costs can be kept low. Frequently, materials having great saturation magnetization are very expensive. By means of the use of such a material only for at least one first tooth segment 22 in the region of the tooth head 14, the material costs for a sheet-metal part 10 and a rotor or a stator composed of a plurality of such sheet-metal parts 10 can be kept low. Such materials are used only where the magnetic properties of the tooth 12 require it; according to the example, this is in the region of the tooth head 14. Other sections of the tooth 12 are optimized by means of the use of other materials.

In the exemplary embodiment illustrated in FIG. 4, in contrast to the first exemplary embodiment according to FIG. 3, only a part of the respective tooth head 14 is formed by at least one first tooth segment 22. According to the example, the tooth head 14 of a tooth 12 has two end sections 24 disposed at opposite ends in the circumference direction U. The two end sections 24 are disposed at a distance from one another in the circumference direction U, and do not touch one another, according to the example. In a modification of the preferred exemplary embodiment described here, the two end sections 24 on the tooth head surface 16 can also follow one another directly.

In the exemplary embodiment according to FIG. 4, the tooth 12, just like in the first exemplary embodiment according to FIG. 3, has a second tooth segment 23 composed of the second material M2. In contrast to the first exemplary embodiment according to FIG. 3, the second tooth segment 23 in the exemplary embodiment according to FIG. 4 extends into the tooth head 14 in the region of the longitudinal center plane L. The second tooth segment 23 forms a center section of the tooth head surface 16, according to the example, in the region of the longitudinal center plane.

In the circumference direction U, the tooth head 14 has two end sections 24 that are formed by a first tooth segment 22, in each instance. Each of the two tooth segments 22 or each end section 24 makes a section of the tooth head surface 16 available, which section follows the center section that is made available by the second tooth segment 23. The two first segments 22 are thereby connected with the second tooth segment 23 of the tooth 12 at a first connection location 25, in each instance. The second tooth segment 23 is connected with the connection part 12 [sic—should be 11] at the second connection location 26, as is also the case in the first exemplary embodiment according to FIG. 3. In contrast to the second exemplary embodiment according to FIG. 4, in the first exemplary embodiment according to FIG. 3 only a first connection location 25 is present, because the tooth head 14 as a whole is formed by a single first tooth segment 22.

The connection at a first connection location 25 and/or at a second connection location 26 is carried out, in the exemplary embodiments according to FIGS. 3 and 4, with a material-fit connection. The material-fit connection can be produced by means of welding, laser welding, adhesion, sintering or another suitable material-fit method of connection. The material-fit connection at a connection location 25, 26 can take place over the full area or partially, for example in point shape or line shape.

In FIGS. 3 and 4, planar connection surfaces are provided at the connection locations 25, 26, in each instance, as represented by the straight-line connection locations 25, 26. It is understood that in modification of this, curved and/or zigzag or any other desired progressions of the first connection location 25 and/or of the second connection location 26 are possible. In particular, the size of the connection surface can be increased at a connection location 25, 26 in question, by means of wave-shaped, zigzag or other non-straight-line progressions of a connection location 25, 26. Aside from mechanical improvements of the connection, the magnetic resistance can also be influenced in this way. The progression of the connection locations 25, 26 also has an influence on the forces in the magnetic field that occur at this boundary surface, by means of the changing relative permeability, which forces act perpendicular to the boundary surface, on the material having the lower relative permeability.

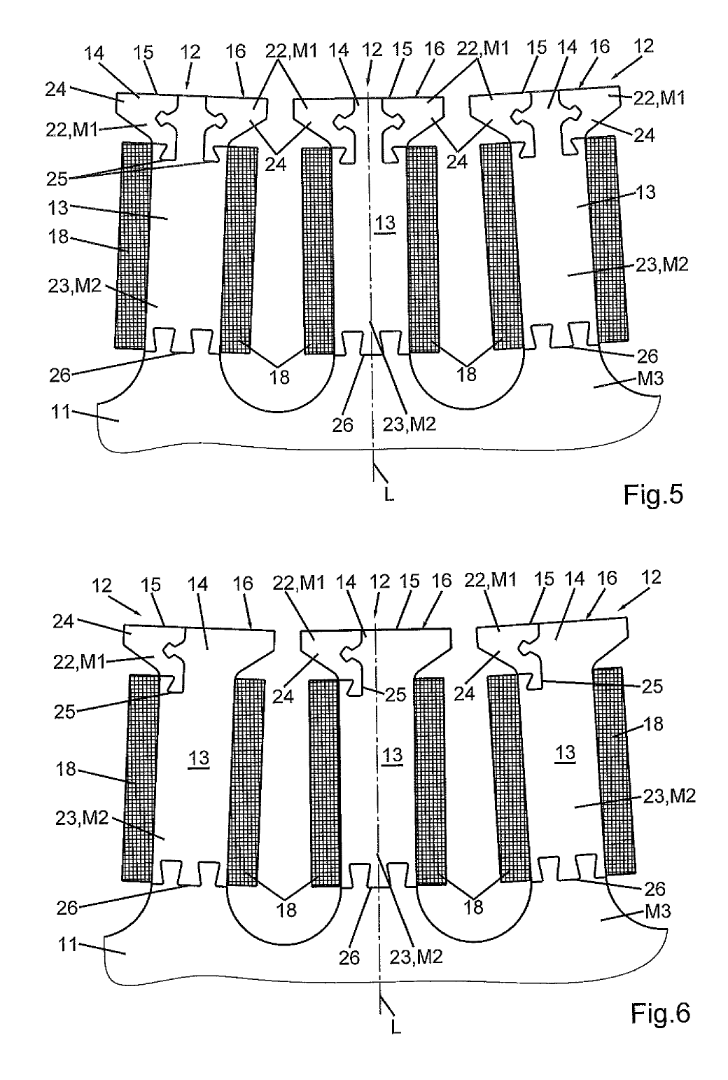

In FIG. 5, a further possibility is illustrated schematically as to how the connection between the tooth segments 22, 23 with one another or with other parts of the sheet-metal part 10 or with the connection part 11 can be implemented. Alternatively, but preferably in addition to the material-fit connection, a form-fit connection can be provided at the first connection location 25 and/or the second connection location 26. For this purpose, the contours of the parts of the tooth 12 to be connected are adapted to one another in such a manner that projections and undercut recesses fit into one another so that a form-fit connection occurs, similar to puzzle pieces that engage into one another or a swallowtail connection. The form-fit connection of the parts of the tooth 12 can take place by means of insertion into one another parallel to the axis of rotation D. Pulling apart the parts connected in this way, transverse to the insertion connection direction (parallel to the axis of rotation D) is prevented. The contours illustrated in FIGS. 5 and 6, which form projections and/or recesses at the connection part 11 and at the second tooth segment 23 as well as at the respective first tooth segment 22, are shown merely as examples. In this regard, any other progressions of the first and/or second connection location are also possible.

In the production of the form-fit connection, a force-fit connection at a first connection location 25 and/or a second connection location 26 can also be produced in addition or alternatively to a material-fit connection.

In the exemplary embodiments according to FIGS. 3 to 5 and 7, each tooth 12 is configured to be symmetrical with regard to its longitudinal center plane L. In contrast to this, it is also possible to structure the tooth 12 to be asymmetrical with regard to the longitudinal center plane L, with reference to the materials used. For example, the tooth 12 can consist of a first tooth segment 22 composed of the first material M1 only on one side of the longitudinal center plane L, at one of the two end sections 24, while the opposite end section, with reference to the longitudinal center plane L, is produced from a different material. In this asymmetrical embodiment, the outer contour of the tooth 12 can continue to be symmetrical relative to the longitudinal center plane L, while the placement of the different tooth segments 22, 23 for formation of the tooth 12 do not demonstrate any symmetry with regard to the longitudinal center plane L.

In the exemplary embodiment according to FIG. 6, therefore only one end section 24 of the tooth head 14 is produced by a first tooth segment 22 and consequently from the first material M1. In accordance with the example, the first material M1 has a first saturation magnetization B_{S1}, which is greater than the second saturation magnetization B_{S2} of the second material M2. Such an embodiment can further reduce the costs for production of a sheet-metal part 10 and is particularly suitable for electrical machines that are moved only or primarily in one rotation direction, about the axis of rotation D. For example, electric motors of vehicles such as passenger cars, motorcycles or bicycles are driven almost exclusively in one rotation direction. Generators of power production plants, such as water power plants, wind power plants, are operated only in one direction. This can be taken into account by means of the asymmetrical configuration according to FIG. 6.

In all the exemplary embodiments, the total volume of the first material M1 of the at least one first tooth segment 22 is less than the total volume of the second material M2 of the at least one second tooth segment 23.

In a modification of the exemplary embodiments illustrated, it is also possible that more than one second tooth segment 23 is present. Furthermore, in a modification of the exemplary embodiments illustrated, the second connection location 26 between the tooth strip 13 and the connection part 11 can be eliminated. It is possible to produce the connection part 11 and the tooth strip 13 or the connection part 11 and the at least one second tooth segment 23 integrally from the same material, without any seam location and join location.

The tooth 12 of a rotor shown in the exemplary embodiment according to FIG. 7 has a modified contour. The tooth head 14 does not project beyond the tooth strip 13 in the circumference direction U. According to the example, this tooth 12 narrows toward its free end 15.

A further aspect of the present invention relates to the tooth 12 of a rotor or stator of an electrical machine provided with permanent magnets 19, which rotor or stator forms a flow guide piece 27 (FIG. 7). Such flow guide pieces 27 can be used to limit the magnetic flow density B in the permanent magnets 19. It is practical if the flow guide pieces 27 project beyond the adjacent permanent magnets 19 in the radial direction, relative to the axis of rotation D, and form the air gap in which the magnetic field H forms, relative to the related tooth 12 of the related stator or rotor. In this way, the permanent magnets 19 can be protected from overly great flow density and thereby from demagnetization.

In FIG. 7, the fundamental method of action of the configuration, according to the invention, of the teeth 12 of a sheet-metal part 10 according to all the exemplary embodiments of the present invention is shown in greatly schematic manner. At the top of the figure, a tooth 12 of a rotor is illustrated in greatly simplified form, which tooth represents a flow guide piece 27 between two permanent magnets 19 here. However, the rotor could also have a sheet-metal part 10 that has one or more windings 18. Let it be assumed, as an example, that the machine is an electric motor.

Some magnetic field lines of the magnetic field H are illustrated between the tooth 12 of the rotor and a tooth 12 of the stator. The rotation direction R of the rotor about the axis of rotation D is shown schematically. The teeth 12 of the sheet-metal parts 10 of the rotor or of the stator are structured as described above.

When the rotor rotates in the rotation direction R, the tooth 12 of the rotor comes close to a tooth 12 being considered (center tooth in FIG. 7). As it comes close, a magnetic field H occurs between the tooth 12 of the rotor and the tooth 12 of the stator being considered. In FIG. 7, the situation where the two teeth 12 being considered partially overlap, viewed radially relative to the axis of rotation, is shown schematically. Great magnetic flow density occurs in the two end sections 24 of the teeth 12 being considered, which have the smallest distance from one another. If the magnetic flow density exceeds the saturation magnetization in the region of the respective end section 24 of the tooth head 14, no further increase in torque can occur by means of a further increase in current in the windings 18 of the stator. A further increase in current would merely lead to the production of heat. For this reason, at least the one end section 24 of each tooth 12 is formed by a first tooth segment 22, which demonstrates great first saturation magnetization B_{S1}. In this way, great torque can be made available for an electric motor.

If the overlap of the two teeth 12 being considered increases during a further rotation of the rotor in the rotation direction R, the magnetic flow density B in the teeth decreases. Accordingly, the entire tooth does not need to be produced from a first material M1 having great first saturation magnetization B_{S1}. It is sufficient to produce those tooth segments that are exposed to great magnetic flow density B and, according to the example, the first tooth segments 22 of a tooth 12 from the first material M1.

The connection part 11 and/or the tooth strip 13 or the second tooth segment 23 can be optimized with regard to other magnetic and/or mechanical and/or physical properties than saturation magnetization. In particular, the second tooth segment 23 and consequently, according to the example, the tooth strip 13 and/or the connection part 11 have great relative permeability, which is greater than that of the first material M1 or has greater mechanical stability than the first material M1. The mechanical stability can be characterized by the tensile strength and/or the modulus of elasticity and/or the hardness of the material.

In all the exemplary embodiments illustrated, the connection part 11 can consist of a magnetizable third material M3, which differs from the first material M1 and the second material M2. In particular, the third material M3 can demonstrate greater mechanical stability than the first material M1 and/or the second material M2. The third material M3 can also differ from the two other materials M1, M2 in terms of the magnetic and/or physical properties.

In the production of the sheet-metal part 10, the method of procedure is as follows:

The first tooth segments 22 of the teeth 12 12 are removed from a first starting metal sheet that consists of the first material M1, are removed from a starting metal sheet that consists of the first material M1. In the same way, the second tooth segments 23 of the teeth 12 are removed from a starting metal sheet that consists of the second material M2. The connection part 11 is removed, if applicable, from a starting metal sheet that consists of the third material M3. If the second tooth segments 23 and the connection part 11 consist of the same material, according to the example the second material M2, the connection part 11 can be removed from the starting metal sheet together with the second tooth segments 23 of the teeth 12, in one operation.

Removal from the starting metal sheet can take place by means of cutting, punching, laser cutting, water-jet cutting or the like.

Preferably, the first tooth segments 22 are removed from the starting metal sheet by means of a special removal method, in order not to negatively impair the magnetic properties at the removal locations by means of the introduction of heat or material flow during removal. It is possible, for example, to carry out the removal process using an advantageous cutting method as described in EP 1 602 419 A1. The method described there is being incorporated into the application by making reference to it.

Subsequent to removal of the individual components, these are connected with one another at the connection locations 25, 26. As has been explained, the second connection locations 26 between the connection part 11 and the second tooth segment 23 or the tooth strip 13 can be eliminated if these two components are integrally formed from the same material and removed from a starting metal sheet together.

Connecting at the connection locations 25 or 26 that are present can take place with a material-fit connection and/or a form-fit connection and/or a force-fit connection. Preferably, a material-fit connection is present at every connection location 25, 26, which connection can be supplemented, if necessary, with a form-fit connection and/or force-fit connection.

The sheet-metal parts of a rotor or of a stator are produced in similar manner and stacked and connected to form a laminated core. This laminated core can then be integrated into the rotor or stator of an electrical machine in usual manner.

The invention relates to a sheet-metal part 10 for a stator or a rotor of an electrical machine, for example an electric motor, as well as to a method for the production of such a sheet-metal part 10. The sheet-metal part 10 has a connection part 11 that runs coaxial to an axis of rotation D, for example. Teeth 12 spaced apart at regular intervals project transversely from the connection part 11. At the free end, each tooth 12 has a tooth head 14, which is connected with the connection part 11 by way of a tooth strip 13. Each tooth has a least one first tooth segment 22 as well as at least one second tooth segment 23. The tooth segments are produced from different magnetizable materials M1, M2. In this way, the materials M1, M2 can be used in the region of the tooth 12 in targeted manner with regard to their magnetic and/or mechanical properties, where they can optimize the magnetic and/or mechanical behavior of the tooth 12 and consequently of the sheet-metal part 10. In particular, at least one first tooth segment 22 is present on the tooth head 14, the saturation magnetization B_{S1} of which segment is greater than that of the remaining sheet-metal part 10.

### PARTS LIST

10 sheet-metal part
11 connection part
12 tooth
13 tooth strip
14 tooth head
15 free end of the tooth head
16 tooth head surface
17 groove
18 winding
19 permanent magnet
22 first tooth segment
23 second tooth segment
24 end section
25 first connection location
26 second connection location
27 flow guide piece
D axis of rotation
L longitudinal center plane
M1 first material
M2 second material
M3 third material
R rotation direction
U circumference direction

1. A sheet-metal part or sintered part (10) for a stator or a rotor of an electrical machine, the sheet metal part comprising:
a connection part (11),
multiple teeth (12) that project away from the connection part (11), which teeth have a tooth head (14) at their free end, in each instance, which head is connected with the connection part (11) by way of a tooth strip (13),
wherein each tooth (12) has at least one first tooth segment (22) composed of a magnetizable first material (M1) and at least one second tooth segment (23) composed of a magnetizable second material (M2), wherein the magnetizable first material (M1) and the magnetizable second material (M2) are different.

2. The sheet-metal part or sintered part according to claim 1,
wherein the magnetizable first material (M1) has greater saturation magnetization (BS) than the magnetizable second material (M2).

3. The sheet-metal part or sintered part according to claim 1,
wherein the magnetizable first material (M1) demonstrates less relative permeability (μr) than the magnetizable second material (M2).

4. The sheet-metal part or sintered part according to claim 1,
wherein a volume proportion of the magnetizable first material (M1) is less than a volume proportion of the magnetizable second material (M2).

5. The sheet-metal part or sintered part according to claim 1, wherein the first tooth segment (22) forms at least a part of the tooth head (14).

6. The sheet-metal part or sintered part according to claim 5,
wherein the tooth head (14) has two first tooth segments (22).

7. The sheet-metal part or sintered part according to claim 6,
wherein the two first tooth segments (22) are disposed at a distance from one another in a circumference direction (U), about an axis of rotation (D).

8. The sheet-metal part or sintered part according to claim 6,
wherein the two first tooth segments (22) are disposed symmetrically relative to a longitudinal center plane (L) through the tooth (12).

9. The sheet-metal part or sintered part according to claim 1, wherein the at least one first tooth segment (22) is disposed asymmetrically relative to a longitudinal center plane (L) through the tooth (12).

10. The sheet-metal part or sintered part according to claim 1, wherein the second tooth segment (23) forms at least a part of the tooth strip (13).

11. The sheet-metal part or sintered part according to claim 1, wherein the connection part (11) and the second tooth segment (23) are composed of the same material (M2).

12. The sheet-metal part or sintered part according to claim 1, wherein the connection part (11) is composed of a magnetizable third material (M3), wherein the magnetizable third material (M3) differs both from the magnetizable first material (M1) and from the magnetizable second material (M2).

13. The sheet-metal part or sintered part according to claim 12,
wherein a tensile strength and/or a modulus of elasticity and/or a hardness of the third material (M3) and/or of the second material (M2) is greater than that of the first material (M1).

14. The sheet-metal part or sintered part according to claim 1, wherein the first tooth segment (22) and/or the second tooth segment (23) are connected with a respective adjacent part of the sheet-metal part or sintered part (23 or 11) with a form-fit connection and/or material-fit connection and/or force-fit connection.

15. The sheet-metal part or sintered part (10) according to claim 1, wherein the connection part (11) is closed in ring shape in a circumference direction (U), about an axis of rotation (D), and the multiple teeth (12) project radially away from the connection part (11) relative to the axis of rotation (D), or that the connection part (11) extends in a straight line or curved along a movement path of the rotor, and the teeth (12) project away from the connection part (11) at a slant or a right angle.

16. A method for production of a sheet-metal part or sintered part (10) for a stator or a rotor of an electrical machine, wherein the sheet-metal part or sintered part (10) has a connection part (11) and multiple teeth (12) that extend away from the connection part (11), which teeth have a tooth head (14) at their free end, in each instance, which head is connected with the connection part (11) by way of a tooth strip (13), the method comprising:
production of at least one first tooth segment (22) for each tooth (12), composed of a magnetizable first material (M1),
production of at least one second tooth segment (23) for each tooth (12), composed of a magnetizable second material (M2), wherein the magnetizable first material (M1) and the magnetizable second material (M2) are different,
connecting the at least one first tooth segment (22) and the at least one second tooth segment (23) with one another or with at least one further component of the sheet-metal part or sintered part (10) to form the teeth (12) of the sheet-metal part or sintered part (10).

17. The method according to claim 16,
wherein the second tooth segments (23) of the teeth (12) are connected with the connection part (11) before or after they are connected with the at least one related first tooth segment (22).
